(19) United States
(12) Patent Application Publication
(10) Pub. No.: US 2019/0012619 A1
(43) Pub. Date: Jan. 10, 2019

(54) REMEDIATING FUTURE SAFETY INCIDENTS

(71) Applicant: TYFOOM, LLC, Springville, UT (US)

(72) Inventors: N. Ryan Moss, Mapleton, UT (US); Amber Beckstrom, Fort Collins, CO (US); Mark L. Nelson, Mapleton, UT (US)

(73) Assignee: TYFOOM, LLC, Springville, UT (US)

(21) Appl. No.: 16/028,129

(22) Filed: Jul. 5, 2018

Related U.S. Application Data
(60) Provisional application No. 62/528,885, filed on Jul. 5, 2017.
(60) Provisional application No. 62/613,922, filed on Jan. 5, 2018.

(51) Int. Cl. G06Q 10/04; G06Q 10/06; G06Q 10/10

(52) U.S. Cl. CPC G06Q 10/04; G06Q 10/10; G06Q 10/06375

(57) ABSTRACT

A method for improving safety and/or training compliance computer systems is described. In one embodiment, the method includes analyzing a plurality of incidents in real time based at least in part on one or more incident criteria; identifying an incident trend among at least one of the one or more incident criteria analyzed; analyzing a training history of at least a first organization that is associated with the incident trend; analyzing a training history of a second organization; and using machine learning to predict a future occurrence of an incident associated with the incident trend based at least in part on the analysis of the training history of the second organization.

### CROSS-REFERENCE TO RELATED APPLICATION

This application claims the benefit of U.S. Provisional Application No. 62/528,885, filed Jul. 5, 2017; and U.S. Provisional Application No. 62/613,922, filed Jan. 5, 2018.

### BACKGROUND

The Occupational Safety and Health Act grants Occupational Safety and Health Administration (OSHA) the authority to issue workplace health and safety regulations. These regulations include limits on hazardous chemical exposure, employee access to hazard information, requirements for the use of personal protective equipment, and requirements to prevent falls and hazards from operating dangerous equipment.

OSHA's current Construction, General Industry, Maritime and Agriculture standards are designed to protect workers from a wide range of serious hazards. Examples of OSHA standards include requirements for employers to: provide fall protection such as a safety harness/line or guardrails, prevent trenching cave-ins, prevent exposure to some infectious diseases, ensure the safety of workers who enter confined spaces, prevent exposure to harmful chemicals, put guards on dangerous machines, provide respirators or other safety equipment, and provide training for certain dangerous jobs in a language and vocabulary workers can understand.

OSHA sets enforceable permissible exposure limits (PELs) to protect workers against the health effects of exposure to hazardous substances, including limits on the airborne concentrations of hazardous chemicals in the air. Employers must also comply with the General Duty Clause of the OSH Act. This clause requires employers to keep their workplaces free of serious recognized hazards and is generally cited when no specific OSHA standard applies to the hazard. However, training and compliance by employers is often lacking.

### SUMMARY

According to at least one embodiment, a method for predicting future safety incidents associated with safety and training compliance is described. In some embodiments, one or more aspects of the method may be performed by one or more processers of a mobile computing device. In some cases, the method may include analyzing a plurality of incidents in real time based at least in part on one or more incident criteria; identifying an incident trend among at least one of the one or more incident criteria analyzed; analyzing a training history of at least a first organization that is associated with the incident trend; analyzing a training history of a second organization; and using machine learning to predict a future occurrence of an incident associated with the incident trend based at least in part on the analysis of the training history of the second organization.

In some cases, the method may include the training history of at least the first organization being based on at least one of a tracked adherence to a training policy, a tracked level of effectiveness of the training policy, a tracked adherence to a safety policy, a tracked level of effectiveness of the safety policy, or any combination thereof, of at least one person associated with the incident trend.

In some cases, the method may include modifying enforcement of the training policy or the safety policy, or both, of at least the first organization upon determining the training history indicates a lack of adherence to at least one of the training policy and the safety policy is likely contributing to the incident trend.

In some cases, the method may include modifying one or more aspects of the training policy or the safety policy, or both, upon determining the training history indicates sufficient adherence by at least the first organization to the training policy and the safety policy.

In some cases, the one or more incident criteria may include at least one of an incident type, an incident industry, an incident organization, an incident person or group of persons, an incident location, or any combination thereof. In some cases, the incident location may include at least one of a job site, an office site, a geographic region, a state or providence, a country, or any combination thereof.

In some cases, the incident type may include a safety violation, a health violation, an environmental violation, accidents involving injury to one or more persons. accidents involving injury to property, accidents involving injury to property. or any combination thereof. In some cases, the injury to one or more persons may include injuries or illnesses that result in unconsciousness, lost work days, restriction in work activity, job transfers, or medical care beyond first aid.

In some cases, the incident trend may include two or more occurrences of incidents sharing at least one common incident criteria. In some cases, the second organization may not contribute to or be independent of the incident trend.

A computing device configured for predicting future safety incidents associated with safety and training compliance is also described. The computing device may include one or more processors and memory in electronic communication with the one or more processors. The memory may store computer executable instructions that when executed by the one or more processors cause the one or more processors to perform the steps of analyzing a plurality of incidents in real time based at least in part on one or more incident criteria; identifying an incident trend among at least one of the one or more incident criteria analyzed; analyzing a training history of at least a first organization that is associated with the incident trend; analyzing a training history of a second organization; and using machine learning to predict a future occurrence of an incident associated with the incident trend based at least in part on the analysis of the training history of the second organization.

A computer-program product for predicting future safety incidents associated with safety and training compliance is also described. The computer-program product may include a non-transitory computer-readable medium storing instructions thereon. When the instructions are executed by one or more processors, the execution of the instructions may cause the one or more processors to perform the steps of analyzing a plurality of incidents in real time based at least in part on one or more incident criteria; identifying an incident trend among at least one of the one or more incident criteria analyzed; analyzing a training history of at least a first organization that is associated with the incident trend; analyzing a training history of a second organization; and using machine learning to predict a future occurrence of an incident associated with the incident trend based at least in part on the analysis of the training history of the second organization.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of an environment in which the present systems and methods may be implemented;

FIG. 2 shows a block diagram of one or more modules in accordance with various aspects of this disclosure

FIG. 3 is a data flow diagram illustrating one embodiment of a method in accordance with various aspects of this disclosure;

FIG. 4 shows a diagram of a system in accordance with various aspects of this disclosure;

FIG. 5 is a flow diagram illustrating one embodiment of a method in accordance with various aspects of this disclosure;

FIG. 6 is a flow diagram illustrating one embodiment of a method in accordance with various aspects of this disclosure;

FIG. 7 depicts a block diagram of a computer system suitable for implementing the present systems and methods; and

FIG. 8 depicts a block diagram of a computer system suitable for implementing the present systems and methods.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The current systems and methods are directed towards predicting future safety incidents associated with, for example, safety guidelines as well as regulations and improving computer systems associated with training and compliance. Currently, training supervisors spend considerable amounts of time tracking employee training and safety compliance. In some cases, a training supervisor may be required to maintain a paper trail in compliance with corporate guidelines as well as local, state, and/or federal laws. The paper trails may include information regarding when a training occurs, a duration of the training (e.g., 1 hour long, etc.), subject matter taught during the training, and a list of who attended the training. As a result, the training supervisor may be required to handle hundreds or thousands of sheets of training logs in order to comply with company safety guidelines and safety regulations associated with local, state, and/or federal law.

In some cases, the systems and methods may include generating one or more series of videos related to a particular topic. In some cases, each video in a given series of videos may be two minutes or shorter. As one example, a first series of videos may be on the topic of safe and proper handling of chemicals, while a second series of videos may be on the topic of safe and proper techniques of lifting objects by hand, while a third series of videos may be on the topic of safe and proper driving of vehicles. As an example, a first video in the series of videos on the topic of safe driving may cover a first aspect of texting and driving, a second video in this series may cover another aspect of texting and driving, a third video in this series may cover impaired driving, a fourth video in this series may cover drowsiness and driving, a fifth video in this series may cover drug use and driving, a sixth video in this series may cover alcohol use and driving, a seventh video in this series may cover obeying traffic laws, an eighth video in this series may cover proper procedures when a vehicle breaks down, a ninth video in this series may cover proper procedures when in a traffic accident, and the like.

In some cases, a company may assign employees to one or more work groups. In some embodiments, each work group may include a title that describes the work group. For example, a first work group of a company may be titled engineers, a second work group may be titled service drivers, and a third work group may be titled manufacturing. Thus, one or more engineers from the company may be assigned to the engineer work group, one or more service drivers may be assigned to the service driver work group, and one or more manufacturing employees may be assigned to the manufacturing work group, etc. In some embodiments, one or more series of videos may be assigned to a particular work group that includes one or more employees. Additionally or alternatively, one or more series of videos may be assigned to an individual employee. Additionally or alternatively, a single video may be assigned to a particular work group and/or individual employee.

When a particular video is scheduled for one or more users and/or groups of users, in some cases, one or more other videos may be auto-scheduled to the one or more users and/or groups of users. In some cases, upon detecting the employee being checked-in to work, the present system and methods may in response send the scheduled daily video prompt to at least one of a designated computing device of the employee, to an application installed on a computing device of the employee, to an email of the employee, and to a text messaging number of the employee, or any combination thereof. In some cases, one or more questions may be displayed on a mobile device before, during, and/or after a video is watched to an employee. In some cases, the questions may be used to verify whether the employee actually watched the video and/or paid attention to the content of the video.

In some cases, the present systems and methods may maintain statistics of an employee in relation to consuming scheduled media content, following training policy, and/or following safety policy. As one example, the statistics may include a number of videos watched overall, a number of videos watched in a specified time period (e.g., week, month, year, etc.), a video watching streak, a number of days without missing a video, a percentage of videos actually watched in relation to a number of videos expected to have watched, a percentage of correctly answered questions in relation to one or more watched videos, a safety rating of the employee, a safety rating of an entity associated with the employee, or any combination thereof.

In some embodiments, a safety rating of an employee may be determined and/or updated (e.g., lowered, maintained, or raised) based at least in part on the employee watching or not watching videos, a frequency of watching videos, the employee taking or not taking quizzes, a frequency of taking quizzes, the employee attending or failing to attend live trainings, the employee reading or failing to read company policies, the employee verifying through specific actions that an action was performed or a policy was read, the employee reporting an incident or failing to report an incident, a reaction time to reporting an incident, a number of incidents associated with the employee, an occurrence of a particular incident associated with the employee, a frequency of incidents associated with the employee, or any combination thereof. In one embodiment, as indicated above an entity may be assigned a safety rating. The safety rating of the entity may be based at least in part on the safety ratings of one or more employees of the entity, Additionally or alternatively, the safety rating of the entity may be based at least in part on actions taken by the entity, actions not taken by the entity, delays in actions taken by the entity, or any combination thereof. In some cases, the safety rating of the entity may be based at least in part on proactive actions taken by the entity (e.g., actions taken before an incident occurs or actions taken to prevent a potential incident from occurring) and on reactive actions taken by the entity (e.g., actions taken after an incident occurs, the entity's reaction time to the incident, etc.). In some cases, a safety rating of an entity may be determined and/or updated (e.g., lowered, maintained, or raised) based at least in part on an updating of the safety rating of one or more employees, the entity reporting an incident or failing to report an incident, a reaction time to reporting an incident, an occurrence of a particular incident. a number of incidents associated with the entity, an incident history, an incident frequency, a severity of one or more incidents, an interaction between the entity and an employee or customer, an interaction between the entity and a regulated agency (e.g., OSHA), environment protection agency (EPA), etc.), a compliance or lack of compliance by the entity to a regulation (e.g., safety regulation, health regulation, environment regulation, etc.), or any combination thereof. In some embodiments, the safety rating may be based at least in part on entity providing measurable training platforms to its employees, maintaining and displaying company policy on health and safety issues, and distributing company policy over a mobile software application to make the policy available at all times to each of its employees. In some cases, the safety rating of the entity may be based at least in part on response and abatement plans established by the entity and the effectiveness of the entity in following through on these plans. In some cases, the safety rating of the entity may be based at least in part on the entity successfully addressing feedback to employee's safety concerns. In some cases, the safety rating of the entity may be based at least in part on actions taken by the entity.

In some cases, the present systems and methods may include a menu for at least one of a dashboard view, employee view, videos view, alerts view, statistics view, settings, or any combination thereof. In some cases, the administrator dashboard may include one or more video schedules. For example, the dashboard may enable an administrator to view a list of videos assigned to an employee and/or a group of employees. In some cases, the list of videos may be shown in a sequence in which they are disbursed to the assigned employees. For example, a first listed video may be disbursed to the assigned employees on a first workday, a second listed video on a second workday following the first workday, and so forth. In some embodiments, the administrator dashboard may include a training statistics window that gives a graphical snapshot of training progress. As one example, the training statistics window may show a percentage of videos watched per a given set of weeks. For instance, the training statistics window may show what percentage of employees watched scheduled videos for the present week and one or more previous weeks. The percentages may apply to all employees, a group of employees, one employee, or any combination thereof. Additionally or alternatively, the training statistics window may show a percentage of correct answers given in training video quizzes. For example, after a training video has been viewed, a quiz may be displayed on the watcher's mobile device asking questions regarding the content of the video he/she just finished watching. Thus, the training statistics window may show what percentage of correct answers were given in training content quizzes. The percentages may apply to all employees, a group of employees, one employee, all media content, or a portion of media content. The media content may include any combination of video files, audio files, image files, videogame files, white papers, and books.

In some cases, a user interface on a user's mobile device may enable the user to create an incident report. In some cases, one or more portions of the incident report may be auto-filled based on information in a user profile of the user. For example, at least one of employee name, employee identifier, physical address, email address, phone number, age, and social security number, or any combination thereof, may be auto-populated in the incident report. In some embodiments, the present systems and methods may enable a user to take one or more photos and/or videos of the incident site and automatically attach the captured photos/videos to the incident report. In some embodiments, the present systems and methods may determine a location of the incident based determining on a location of a device of a user determined to be at the location of the incident. In some cases, the present systems and methods may automatically send the incident report to one or more predetermined recipients. In some cases, the present systems and methods may identify a severity of the incident and determine recipients of the incident report based on the determined severity. As one example, the present systems and methods may determine one or more government agencies required to receive notification of the incident by a certain deadline and automatically provide a report of the incident before the certain deadline. In some cases, the present systems and methods may provide instructions based on the indicated severity. In some cases, the present systems and methods may provide training based on the severity. For example, the present systems and methods may provide instructions in a certain order such as first do actions A, B, and C; then do action D, then do actions E and F, do not do action G, then do action H, etc. In some cases, a safety rating of an employee and/or an entity associated with the employee may be updated based on creation of the incident report. In some examples, a safety rating of an employee and/or an entity associated with the employee may be updated based on a failure to create an incident report. In some cases, an employee, an administrator, and/or an executive of an entity may create an alert, which may be automatically sent to one or more predetermined recipients. Examples of an alert may include a road condition alert, a weather alert, a product recall alert, a product safety alert, a public safety alert, an alert of an accident that has occurred, and the like. In some cases, the alert may include at least a high level alert, a medium level alert, and a low level alert. In some cases, the present systems and methods may track who has received the alert, who has received the alert and viewed the alert, who has received the alert and not viewed the alert, and perform one or more operations based on at least one of these determinations.

In some embodiments, the present techniques may include analyzing a plurality of incidents in real time based at least in part on one or more incident criteria, identifying an incident trend among at least one of the one or more incident criteria analyzed, and analyzing a training history of at least a first organization that is associated with the incident trend. In some cases, the techniques may include identifying two or more incident trends. In one example, the present techniques may identify a trend in ladder-related accidents associated with one or more persons, one or more organization, one or more locations, or any combination thereof. In some embodiments, the present techniques may include analyzing a training history of a second organization and using machine learning to predict a future occurrence of an incident associated with the incident trend based at least in part on the analysis of the training history of the second organization. In some embodiments, the present techniques may include performing a risk assessment of a person, group of persons, organization, group of organizations, industry, or group of industries based at least in part on the analysis of the training history of one or more organizations (e.g., the first organization and/or the second organization, etc.).

In some embodiments, the present techniques may use one or more blockchains. A blockchain includes a continuously growing list of records called blocks that are linked and secured using cryptography. In some cases, the blocks may store data such as training history, incidents, and/or information about incident trends. In some cases, a subsequent block may include a cryptographic hash of a previous block, linking the two blocks where linked blocks create a chain of blocks. In some cases, a block may include a timestamp. In some cases, the blockchain may be managed autonomously using a peer-to-peer network and a distributed timestamping server. The peer-to-peer network may be configured to adhere to a protocol for inter-node communication and validating new blocks. Once recorded, the data in any given block cannot be altered retroactively without alteration of all subsequent blocks, which requires consensus of the network majority. In some examples, a block may be authenticated by mass collaboration powered by collective self-interests. In some cases, the blockchain may include a public blockchain, a private blockchain, or a consortium blockchain.

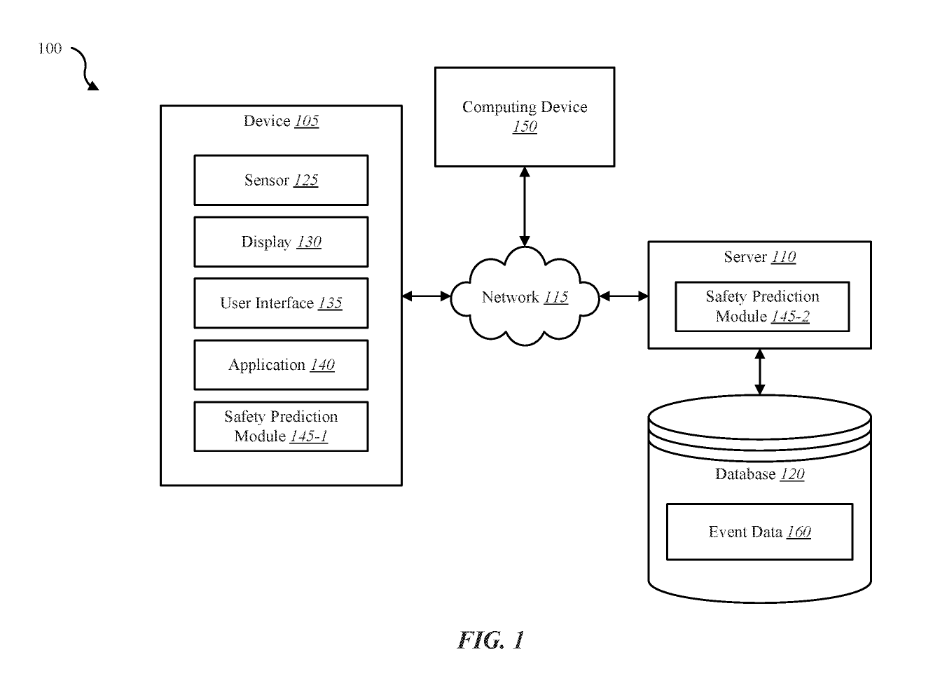

FIG. 1 is a block diagram illustrating one embodiment of an environment 100 in which the present systems and methods may be implemented. In some embodiments, the systems and methods described herein may be performed on a device (e.g., device 105). As depicted, the environment 100 may include a device 105, server 110, a computing device 150, and a network 115 that allows the device 105, the server 110, and computing device 150, to communicate with one another.

Examples of the device 105 may include any combination of mobile devices, smart phones, wearable computing devices (e.g., computer watch, computer eyewear, etc.), personal computing devices, computers, laptops, desktops, servers, media content set top boxes, digital video recorders (DVRs), or any combination thereof. In some cases, device 105 may include a device integrated within computing device 150, and/or as depicted, may be in communication with one or more remote devices via network 115.

Examples of computing device 150 may include at least one of one or more client machines, one or more mobile computing devices, one or more laptops, one or more desktops, one or more servers, one or more media set top boxes, or any combination thereof.

Examples of server 110 may include any combination of a data server, a cloud server, proxy server, mail server, web server, application server, database server, communications server, file server, home server, mobile server, name server, or any combination thereof. Although computing device 150 is depicted as connecting to device 105 via network 115, in one embodiment, device 105 may connect directly to computing device 150. In some cases, device 105 may connect or attach to computing device 150 and/or server 110 via a wired and/or wireless connection. In some cases, device 105 may attach to any combination of a port, socket, and slot of computing device 150 and/or server 110.

In some configurations, the device 105 may include a sensor 125, a display 130, a user interface 135, one or more applications 140, and safety prediction module 145-1. As shown, in some cases server 110 may include safety prediction module 145-2, which may be an example of safety prediction module 145-1. In some cases, a safety prediction module may be installed on both device 105 and server 110, or on device 105 and not server 110, or on server 110 and not device 105. Although the components of the device 105 are depicted as being internal to the device 105, it is understood that one or more of the components may be external to the device 105 and connect to device 105 through wired and/or wireless connections. In some embodiments, application 140 may be installed on computing device 150 in order to allow a user to interface with a function of device 105, safety prediction module 145-1, computing device 150, and/or server 110.

Examples of sensor 125 may include any combination of a camera sensor, audio sensor, proximity sensor, boundary sensor, accelerometer, gyroscope, global positioning system (GPS) sensor, local positioning system (LPS) sensor, Wi-Fi positioning system sensor, near-field sensor, movement sensor, microphone sensor, voice sensor, life sign sensors, other types of sensors, actuators, or combinations thereof. Sensor 125 may represent one or more separate sensors or a combination of two or more sensors in a single device. For example, sensor 125 may represent one or more camera sensors of device 105. For example, sensor 125 may include at least one of a front-facing camera and a rear facing camera. In some cases, sensor 125 may include one or more speakers. Sensor 125 may be integrated with an identity detection system such as a facial recognition system and/or a voice recognition system.

In some embodiments, device 105 may communicate with server 110 via network 115. Examples of network 115 may include any combination of cloud networks, local area networks (LAN), wide area networks (WAN), virtual private networks (VPN), wireless networks (using 802.11, for example), cellular networks (using 3G and/or LTE, for example), etc. In some configurations, the network 115 may include the Internet. It is noted that in some embodiments, the device 105 may not include safety prediction module 145-1. For example, device 105 may include an application 140 that allows device 105 to interface with a separate device via safety prediction module 145-1 located on another device such as computing device 150 and/or server 110. In some embodiments, device 105, computing device 150, and server 110 may include safety prediction module 145-1 where at least a portion of the functions of safety prediction module 145-1 are performed separately and/or concurrently on device 105, computing device 150, and/or server 110. Likewise, in some embodiments, a user may access the functions of device 105 (directly or through device 105 via safety prediction module 145-1) from computing device 150. For example, in some embodiments, computing device 150 includes a mobile application that interfaces with one or more functions of device 105, safety prediction module 145-1, and/or server 110.

In some embodiments, server 110 may be coupled to a database 120. Database 120 may be internal or external to the server 110. In one example, device 105 may be coupled to database 120. For example, in one embodiment database 120 may be internally or externally connected directly to device 105. Additionally or alternatively, database 120 may be internally or externally connected directly to computing device 150 and/or or one or more network devices such as a gateway, switch, router, intrusion detection system, etc. Database 120 may include event data 160. As one example, device 105 may access event data 160 in database 120 over network 115 via server 110. Event data 160 may include data of and/or regarding at least one of media content such as training videos, safety videos, scheduled pause requests, approved pause times, user profile information, live training information, alerts, incident reports, and statistics, or any combination thereof.

Safety prediction module 145-1 may enable an improvement of safety and/or training compliance associated with, for example, legal and/or corporation mandates. In some embodiments, safety prediction module 145-1 may be configured to perform the systems and methods described herein in conjunction with user interface 135 and application 140. User interface 135 may enable a user to interact with, control, and/or program one or more functions of safety prediction module 145-1. Further details regarding the safety prediction module 145-1 are discussed below.

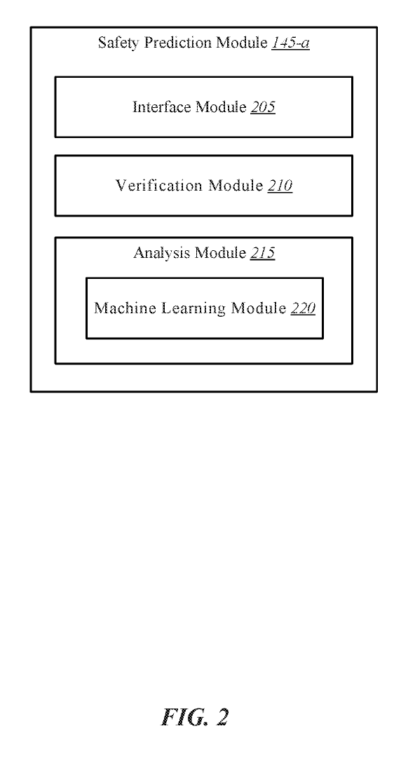

FIG. 2 is a block diagram illustrating one example of safety prediction module 145-a. Safety prediction module 145-a may be one example of safety prediction module 145 depicted in FIG. 1. As depicted, safety prediction module 145-a may include interface module 205, verification module 210, and analysis module 215. As shown, in some embodiments analysis module 215 may include a machine learning module 220.

In one embodiment, one or more operations of safety prediction module 145-a, interface module 205, verification module 210, analysis module 215, or machine learning module 220, or any combination thereof, may be performed in conjunction with and/or by a computing device. As one example, one or more of the operations may be performed in conjunction and/or by a mobile computing device or a mobile application, or both. In some cases, one or more of the operations may be performed automatically without human intervention. In one embodiment, interface module 205 may be configured to generate a safety rating of an entity, the entity including a corporation, a partnership, a company, an organization, an institution, or any group of people, or any combination thereof.

In one embodiment, safety prediction module 145-a may perform one or more operations to predict future safety incidents. In some cases, at least a portion of the operations may be performed by safety prediction module 145-a in conjunction with one or more computing devices comprising at least one processor. In one embodiment, analysis module 215 may be configured to analyze a plurality of incidents in real time based at least in part on one or more incident criteria. In some cases, the one or more incident criteria may include at least one of an incident type, an incident industry, an incident organization, an incident person or group of persons, an incident location, or any combination thereof. In some cases, the incident location may include at least one of a job site, an office site, a geographic region, a state or providence, a country, or any combination thereof. In some cases, the incident type may include a safety violation, a health violation, an environmental violation accidents involving injury to one or more persons, accidents involving injury to property, accidents involving injury to property, or any combination thereof. In some cases, the injury to one or more persons may include injuries or illnesses that result in unconsciousness, lost work days, restriction in work activity, job transfers, or medical care beyond first aid. Thus, analysis module 215 may be configured to analyze a plurality of incidents of a particular type that have occurred and/or as they occur in real time, to analyze a plurality of incidents that have occurred and/or as they occur in real time by a particular person or group of persons, to analyze a plurality of incidents that have occurred and/or as they occur in real time at a particular location, to analyze a plurality of incidents that have occurred and/or as they occur in real time in a particular industry, or any combination thereof.

In some embodiments, interface module 205, in conjunction with analysis module 215, may be configured to identify an incident trend among at least one of the one or more incident criteria analyzed. In some cases, the incident trend may include two or more occurrences of incidents sharing at least one common incident criteria. For example, the incident trend may include the same incident type occurring two or more times, the same person or multiple persons involved in repeats of the same incident type or in different types of incidents, same organization involved in repeats of the same incident type or in different types of incidents, the same industry or multiple industries involved in repeats of the same incident type or in different types of incidents, the same region or multiple regions involved in repeats of the same incident type or in different types of incidents, the same country or multiple countries involved in repeats of the same incident type or in different types of incidents, or any combination thereof.

In one embodiment, analysis module 215 may be configured to analyze a training history of at least a first organization that is associated with the incident trend. For example, upon determining an incident trend exists, analysis module 215 may identify each person, organization, industry, and/or geographic region associated with the incident trend. For instance, analysis module 215 may determine that at least one particular person was involved in and/or contributed to the incident trend, that at least one organization was involved in and/or contributed to the incident trend, and/or at least one industry was involved in and/or contributed to the incident trend. Thus, upon identifying person X as a contributor to the incident trend, analysis module 215 may analyze the training history of person X to determine whether person X has received training, is currently receiving training, is watching training videos, a frequency at which person X watches training videos, a percentage rate at which person X watches each video assigned to him/her, a quiz performance of person X, whether person X performs safety checklists, or any combination thereof. Similarly, analysis module 215 may analyze the training history of one or more persons identified as contributors to the incident trend. In some cases, the one or more additional persons may be of the same organization, of different organizations, of the same industry, of multiple industries, of the same geographical region, of multiple geographical regions, or any combination thereof.

In one embodiment, after identifying the training history of those that contribute to the incident trend, analysis module 215 may be configured to analyze a training history of one or more persons, organizations, industries, and/or regions not identified as contributing to the incident trend. In some embodiments, machine learning module 220 may be configured to predict a future occurrence of an incident associated with the incident trend based at least in part on the analysis of the training history of the one or more persons, organizations, industries, and/or regions not identified as contributing to the incident trend. For example, analysis module 215 may identify one or more persons at a second organization being at risk for causing one or more incidents that may contribute to the incident trend based at least in part on identified similarities between the training history of the one or more persons at the second organization and the training history of those that contribute to the incident trend.

In some cases, the training history of those that contribute to the incident trend may be based on at least one of their tracked adherence to a training policy, the tracked level of effectiveness of the training policy, their tracked adherence to a safety policy, the tracked level of effectiveness of the safety policy, or any combination thereof. In some embodiments, machine learning module 220 may be configured to modify enforcement of the training policy or the safety policy, or both, upon determining the training history indicates a lack of adherence by those that contribute to the incident trend to the training policy and/or the safety policy. For example, analysis module 215 may determine that the lack of adherence by those that contribute to the incident trend likely contributed to the incident trend, and thus warrants modification to how the training policy and/or safety policy is enforced in each organization that contributed to the incident trend. For instance, machine learning module 220 may determine that persons in the affected organizations do not watch all the videos assigned to them, that they don't take quizzes or each quiz, that they score poorly on quizzes, that they don't perform safety checklists or don't complete safety checklists, that they don't follow safety policy, or any combination thereof.

In some embodiments, machine learning module 220 may be configured to modify one or more aspects of the training policy or the safety policy, or both, upon determining the training history indicates sufficient adherence by at least the first organization to the training policy and the safety policy. For example, analysis of the training history may indicate that persons in the affected organizations do, at least on average, watch all the videos assigned to them, that they do take quizzes or each quiz, that they score well on quizzes, that they do perform safety checklists, that they do complete safety checklists, that they do follow safety policy, or any combination thereof, to at least a sufficient degree. In some cases, analysis module 215 may average the training history of the affected organizations and determine whether the average performance in the training history satisfies a performance threshold. Upon determining the average performance exceeds the performance threshold, analysis module 215 may determine that deficient adherence to the training history is not a likely cause of the incident trend. However, situations where adherence to training policy and/or safety policy is not an issue may indicate that the content of the training policy and/or safety policy is deficient to some extent. Accordingly, machine learning module 220 may analyze the training policy and/or safety policy to determine whether deficient content is a likely cause of the incident trend. Upon determining deficient content (e.g., lack of content, incorrect content, etc.) is a likely cause of the incident trend, machine learning module 220 may be configured to modify one or more aspects of the training policy or the safety policy, or both.

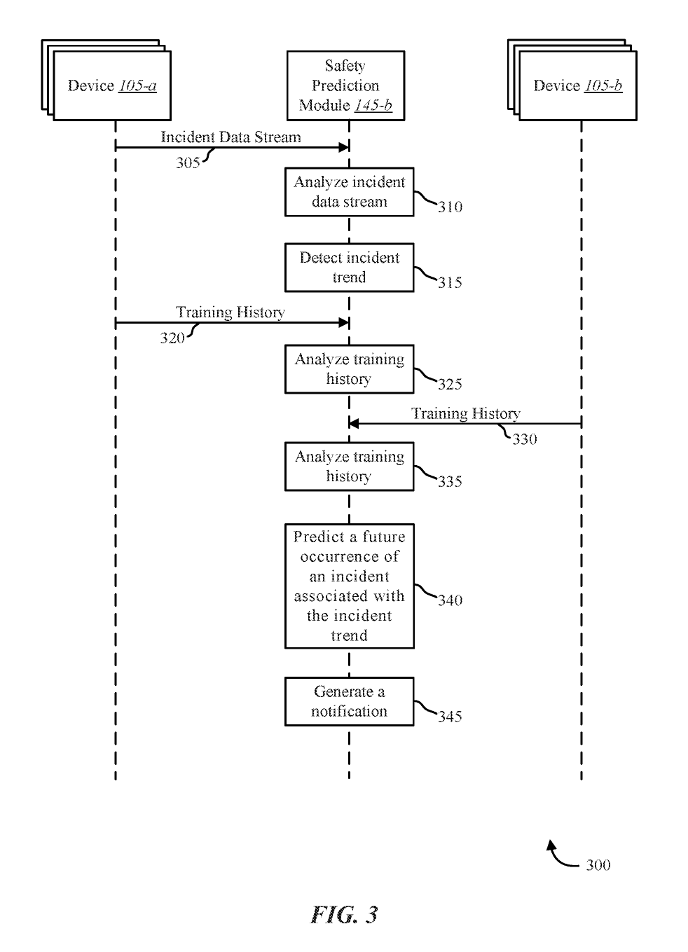

FIG. 3 shows a data flow diagram 300 for predicting future safety incidents, in accordance with various examples. As shown, diagram 300 may include at least first device 105-a, safety prediction module 145-b, and at least device 105-b. Safety prediction module 145-b may be an example of safety prediction module 145-1 of FIG. 1, safety prediction module 145-2 of FIG. 1, and/or safety prediction module 145-a of FIG. 2.

In one example, at 305 safety prediction module 145-b may receive incident data stream 305 from at least device 105-a. The incident data stream 305 may include real-time incident data gather from at least device 105-a. At block 310, safety prediction module 145-b may analyze the incident data stream. At block 315, safety prediction module 145-b may detect an incident trend based at least in part on the analysis from block 310. In one embodiment, the incident trend may indicate that a person, group of persons, organization, group of organization, industry, or multiple industries, or any combination thereof, may be associated with the incident trend. For example, the analysis may indicate that the person, group of persons, organization, group of organization, industry, or multiple industries, or any combination thereof, may be a cause of the incident trend. At 320, safety prediction module 145-b may receive training history from at least device 105-a. At block 325, safety prediction module 145-b may analyze the training history from at least device 105-a. In some cases, the training history at 320 may indicate a training history of the person, group of persons, organization, group of organization, industry, or multiple industries, or any combination thereof, associated with the incident trend.

At 330, safety prediction module 145-b may receive the training history from at least device 105-b. In some cases, at least device 105-b may be identified as a device not associated with the incident trend. For example, at least device 105-b may be associated with a person, group of persons, organization, group of organization, industry, or multiple industries, or any combination thereof, not associated with the incident trend. For instance, device 105-b may be at least one device that is part of an organization that has not contributed to the incident trend. At block 335, safety prediction module 145-b may analyze the training history associated with at least device 105-b. The training history of at least device 105-b may include the training history of a person, group of persons, organization, group of organization, industry, or multiple industries, or any combination thereof, not associated with the incident trend. At block 340, safety prediction module 145-b may predict a future occurrence of an incident associated with the incident trend caused by a person, group of persons, organization, group of organization, industry, or multiple industries, or any combination thereof based at least in part on the analysis of the training history from at least device 105-b. For example, safety prediction module 145-b may identify similarities between the training history from at least device 105-a and the training history from at least device 105-b that indicates a person is likely to cause an incident that will contribute to the incident trend. Accordingly, at block 345, safety prediction module 145-b may generate a notification indicating the predicted future occurrence of an incident similar to those incidents that have contributed to the incident trend. In some cases, safety prediction module 145-b may send the notification to one or more predetermined persons such as an administrator or user associated with device 105-b for example.

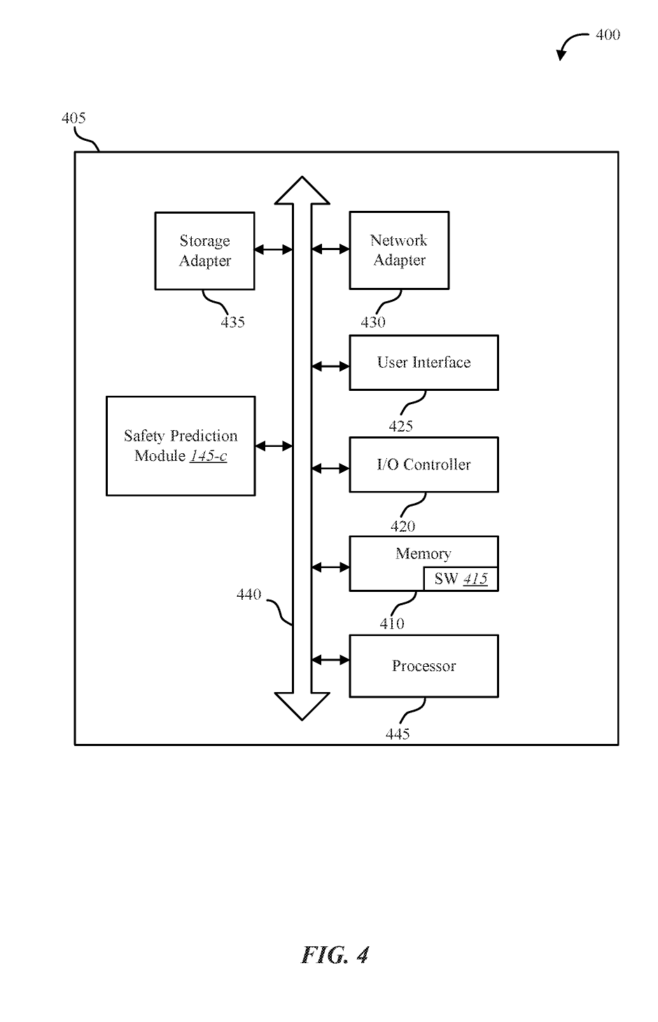

FIG. 4 shows a system 400 for predicting future safety incidents, in accordance with various examples. System 400 may include an apparatus 405, which may be an example of any one of device 105 of FIG. 1.

Apparatus 405 may include components for bi-directional data communications including components for transmitting communications and components for receiving communications. For example, apparatus 405 may communicate bi-directionally with one or more storage devices and/or client systems. This bi-directional communication may be direct (apparatus 405 communicating directly with a storage system, for example) and/or indirect (apparatus 405 communicating indirectly with a client device through a server, for example). Apparatus 405 may also include a processor module 445, and memory 410 (including software/firmware code (SW) 415), an input/output controller module 420, a user interface module 425, a network adapter 430, and a storage adapter 435. The software/firmware code 415 may be one example of a software application executing on apparatus 405. The network adapter 430 may communicate bi-directionally, via one or more wired links and/or wireless links, with one or more networks and/or client devices. In some embodiments, network adapter 430 may provide a direct connection to a client device via a direct network link to the Internet via a POP (point of presence). In some embodiments, network adapter 430 of apparatus 405 may provide a connection using wireless techniques, including digital cellular telephone connection, Cellular Digital Packet Data (CDPD) connection, digital satellite data connection, and/or another connection. The apparatus 405 may include safety prediction module 145-c, which may perform the functions described above for the safety prediction module 145 of FIGS. 1, 2, and/or 3. The signals associated with system 400 may include wireless communication signals such as radio frequency, electromagnetics, local area network (LAN), wide area network (WAN), virtual private network (VPN), wireless network (using 802.11, for example), cellular network (using 3G and/or LTE, for example), and/or other signals. The network adapter 430 may enable one or more of WWAN (GSM, CDMA, and WCDMA), WLAN (including Wi-Fi and/or near field wireless), WMAN (WiMAX) for mobile communications, antennas for Wireless Personal Area Network (WPAN) applications (including RFID and UWB), or any combination thereof. One or more buses 440 may allow data communication between one or more elements of apparatus 405 such as processor module 445, memory 410, I/O controller module 420, user interface module 425, network adapter 430, and storage adapter 435, or any combination thereof.

The memory 410 may include random access memory (RAM), read only memory (ROM), flash memory, and/or other types. The memory 410 may store computer-readable, computer-executable software/firmware code 415 including instructions that, when executed, cause the processor module 445 to perform various functions described in this disclosure. Alternatively, the software/firmware code 415 may not be directly executable by the processor module 445 but may cause a computer (when compiled and executed, for example) to perform functions described herein. Alternatively, the computer-readable, computer-executable software/firmware code 415 may not be directly executable by the processor module 445, but may be configured to cause a computer, when compiled and executed, to perform functions described herein. The processor module 445 may include an intelligent hardware device, for example, a central processing unit (CPU), a microcontroller, an application-specific integrated circuit (ASIC), field programmable gate array (FPGA), or any combination thereof. In some embodiments, the memory 410 may contain, among other things, the Basic Input-Output system (BIOS) which may control basic hardware and/or software operation such as the interaction with peripheral components or devices. For example, at least a portion of the safety prediction module 145-c to implement the present systems and methods may be stored within the system memory 410. Applications resident with system 400 are generally stored on and accessed via a non-transitory computer readable medium, such as a hard disk drive or other storage medium. Additionally, applications can be in the form of electronic signals modulated in accordance with the application and data communication technology when accessed via a network interface such as network adapter 430.

Many other devices and/or subsystems may be connected to and/or included as one or more elements of system 400 (for example, a personal computing device, mobile computing device, smart phone, server, internet-connected device, cell radio module, or any combination thereof). In some embodiments, all of the elements shown in FIG. 4 need not be present to practice the present systems and methods. The devices and subsystems can be interconnected in different ways from that shown in FIG. 4. In some embodiments, an aspect of some operation of a system, such as that shown in FIG. 4, may be readily known in the art and are not discussed in detail in this application. Code to implement the present disclosure can be stored in a non-transitory computer-readable medium such as one or more of system memory 410 or other memory. The operating system provided on I/O controller module 420 may be a mobile device operation system, a desktop/laptop operating system, or another known operating system. The I/O controller module 420 may operate in conjunction with network adapter 430 and/or storage adapter 435. The network adapter 430 may enable apparatus 405 with the ability to communicate with client devices such as device 105 of FIG. 1, and/or other devices over a communication network. Network adapter 430 may provide wired and/or wireless network connections. In some cases, network adapter 430 may include an Ethernet adapter or Fibre Channel adapter. Storage adapter 435 may enable apparatus 405 to access one or more data storage devices such as storage device 110. The one or more data storage devices may include two or more data tiers each. The storage adapter 435 may include one or more of an Ethernet adapter, a Fibre Channel adapter, Fibre Channel Protocol (FCP) adapter, a SCSI adapter, and iSCSI protocol adapter.

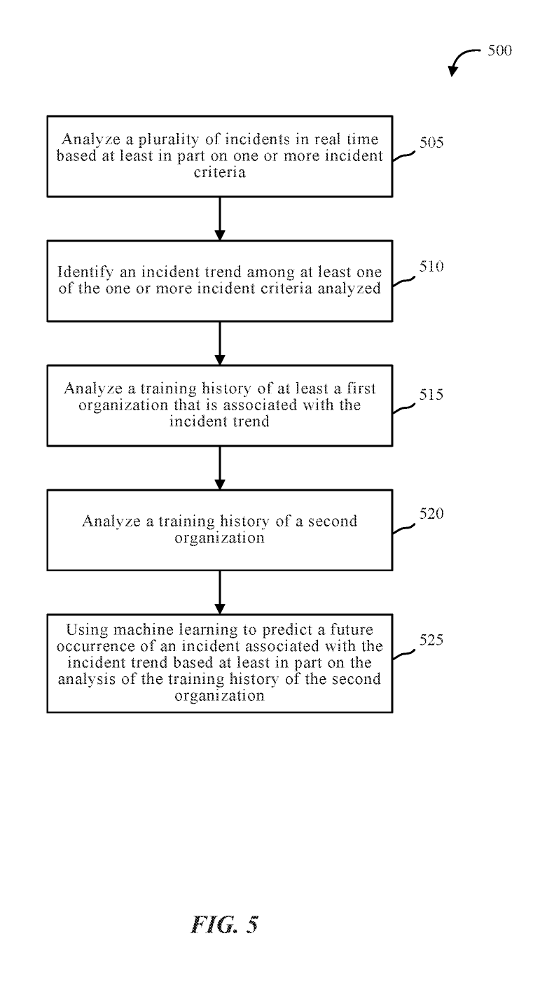

FIG. 5 is a flow diagram illustrating one embodiment of a method 500 for improving safety and training compliance. In some configurations, the method 500 may be implemented by the safety prediction module 145 illustrated in FIGS. 1, 2, 3, and/or 4. In some configurations, the method 500 may be implemented in conjunction with device 105, server 110, network 115, database 120, components thereof, or any combination thereof.

At block 505, method 500 may include analyzing a plurality of incidents in real time based at least in part on one or more incident criteria. At block 510, method 500 may include identifying an incident trend among at least one of the one or more incident criteria analyzed. At block 515, method 500 may include analyzing a training history of at least a first organization that is associated with the incident trend. At block 520, method 500 may include analyzing a training history of a second organization. At block 525, method 500 may include using machine learning to predict a future occurrence of an incident associated with the incident trend based at least in part on the analysis of the training history of the second organization.

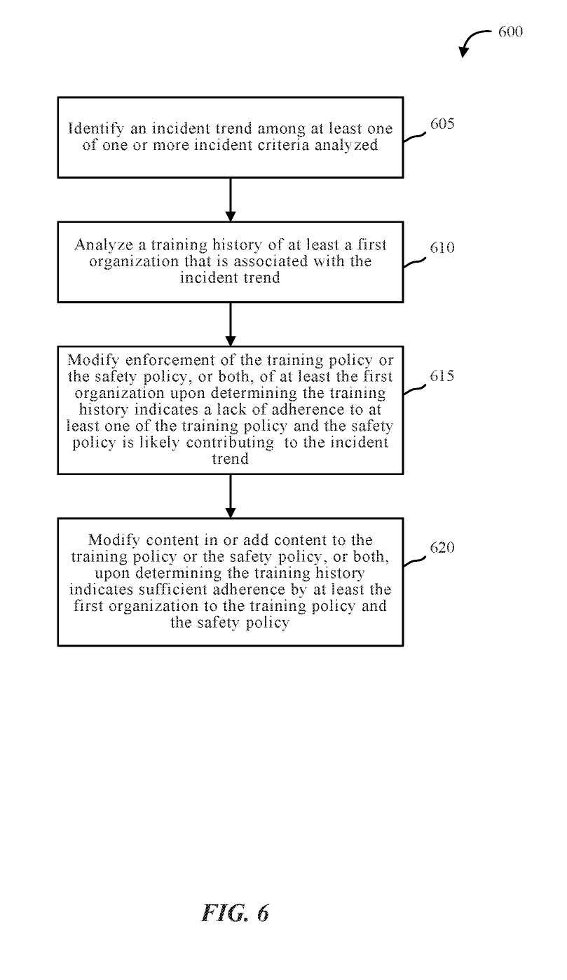

FIG. 6 is a flow diagram illustrating one embodiment of a method 600 for improving safety and training compliance. In some configurations, the method 600 may be implemented by the safety prediction module 145 illustrated in FIGS. 1, 2, 3, and/or 4. In some configurations, the method 600 may be implemented in conjunction with device 105, server 110, network 115, database 120, components thereof, or any combination thereof.

At block 605, method 600 may include identifying an incident trend among at least one of one or more incident criteria analyzed. At block 610, method 600 may include analyzing a training history of at least a first organization that is associated with the incident trend. At block 615, method 600 may include modifying enforcement of the training policy or the safety policy, or both, of at least the first organization upon determining the training history indicates a lack of adherence to at least one of the training policy and the safety policy is likely contributing to the incident trend. At block 620, method 600 may include modifying content in and/or adding content to the training policy or the safety policy upon determining the training history indicates sufficient adherence by at least the first organization to the training policy and the safety policy. For example, method 600 may include modifying content in one or more existing videos, modifying content in a checklist, modifying content in a policy, adding content to one or more existing videos, adding one or more new videos, adding content to a policy, adding a new policy, etc. In some cases, method 600 may include modifying content in and adding content to at least one of the training policy and the safety policy. Additionally or alternatively, method 600 may include removing content from the training policy or the safety policy upon determining the training history indicates sufficient adherence by at least the first organization to the training policy and the safety policy. For example, method 600 may include removing content from one or more existing videos, removing content from a checklist, removing content from a policy, etc.

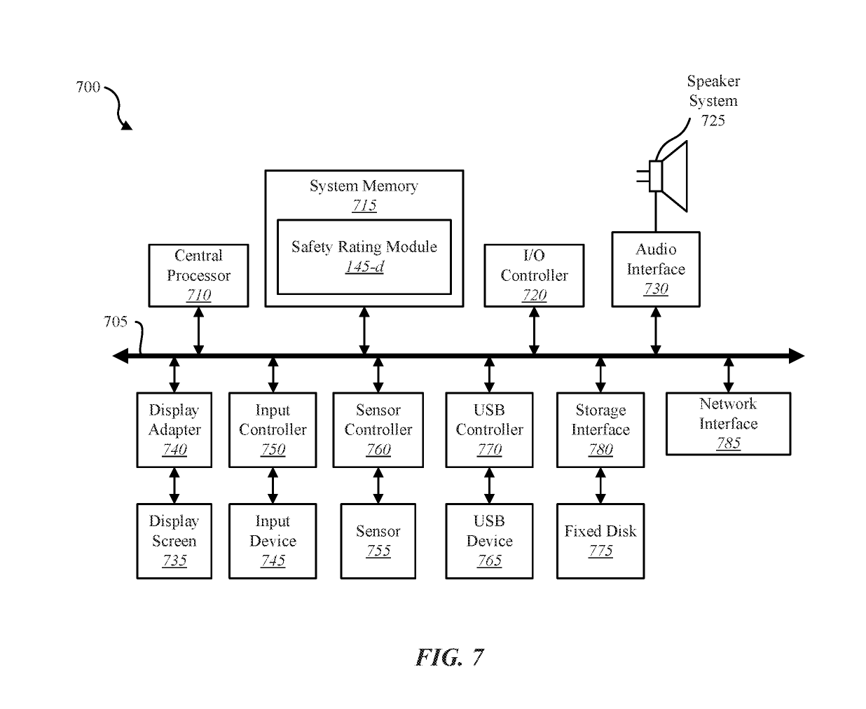

FIG. 7 depicts a block diagram of a computing device 700 suitable for implementing the present systems and methods. The device 700 may be an example of device 105, computing device 150, and/or server 110 illustrated in FIG. 1, and/or apparatus 405 of FIG. 4. In one configuration, device 700 includes a bus 705 which interconnects major subsystems of device 700, such as a central processor 710, a system memory 715 (typically RAM, but which may also include ROM, flash RAM, or the like), an input/output controller 720, an external audio device, such as a speaker system 725 via an audio output interface 730, an external device, such as a display screen 735 via display adapter 740, an input device 745 (e.g., remote control device interfaced with an input controller 750), multiple USB devices 765 (interfaced with a USB controller 770), and a storage interface 780. Also included are at least one sensor 755 connected to bus 705 through a sensor controller 760 and a network interface 785 (coupled directly to bus 705).

Bus 705 allows data communication between central processor 710 and system memory 715, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the safety prediction module 145-d to implement the present systems and methods may be stored within the system memory 715. Applications (e.g., application 140) resident with device 700 are generally stored on and accessed via a non-transitory computer readable medium, such as a hard disk drive (e.g., fixed disk 775) or other storage medium. Additionally, applications can be in the form of electronic signals modulated in accordance with the application and data communication technology when accessed via interface 785.

Storage interface 780, as with the other storage interfaces of device 700, can connect to a standard computer readable medium for storage and/or retrieval of information, such as a fixed disk drive 775. Fixed disk drive 775 may be a part of device 700 or may be separate and accessed through other interface systems. Network interface 785 may provide a direct connection to a remote server via a direct network link to the Internet via a POP (point of presence). Network interface 785 may provide such connection using wireless techniques, including digital cellular telephone connection, Cellular Digital Packet Data (CDPD) connection, digital satellite data connection, or the like. In some embodiments, one or more sensors (e.g., motion sensor, smoke sensor, glass break sensor, door sensor, window sensor, carbon monoxide sensor, and the like) connect to device 700 wirelessly via network interface 785.

Many other devices and/or subsystems may be connected in a similar manner (e.g., entertainment system, computing device, remote cameras, wireless key fob, wall mounted user interface device, cell radio module, battery, alarm siren, door lock, lighting system, thermostat, home appliance monitor, utility equipment monitor, and so on). Conversely, all of the devices shown in FIG. 7 need not be present to practice the present systems and methods. The devices and subsystems can be interconnected in different ways from that shown in FIG. 7. The aspect of some operations of a system such as that shown in FIG. 7 are readily known in the art and are not discussed in detail in this application. Code to implement the present disclosure can be stored in a non-transitory computer-readable medium such as one or more of system memory 715 or fixed disk 775. The operating system provided on device 700 may be iOS®, ANDROID®, MS-DOS®, MS-WINDOWS®, OS/2®, UNIX®, LINUX®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The signals associated with system 700 may include wireless communication signals such as radio frequency, electromagnetics, local area network (LAN), wide area network (WAN), virtual private network (VPN), wireless network (using 802.11, for example), cellular network (using 3G and/or LTE, for example), and/or other signals. The network interface 785 may enable one or more of WWAN (GSM, CDMA, and WCDMA), WLAN (including BLUETOOTH® and Wi-Fi), WMAN (WiMAX) for mobile communications, antennas for Wireless Personal Area Network (WPAN) applications (including RFID and UWB), etc.

The I/O controller 720 may operate in conjunction with network interface 785 and/or storage interface 780. The network interface 785 may enable system 700 with the ability to communicate with client devices (e.g., device 105 of FIG. 1), and/or other devices over the network 115 of FIG. 1. Network interface 785 may provide wired and/or wireless network connections. In some cases, network interface 785 may include an Ethernet adapter or Fibre Channel adapter. Storage interface 780 may enable system 700 to access one or more data storage devices. The one or more data storage devices may include two or more data tiers each. The storage interface 780 may include one or more of an Ethernet adapter, a Fibre Channel adapter, Fibre Channel Protocol (FCP) adapter, a SCSI adapter, and iSCSI protocol adapter.

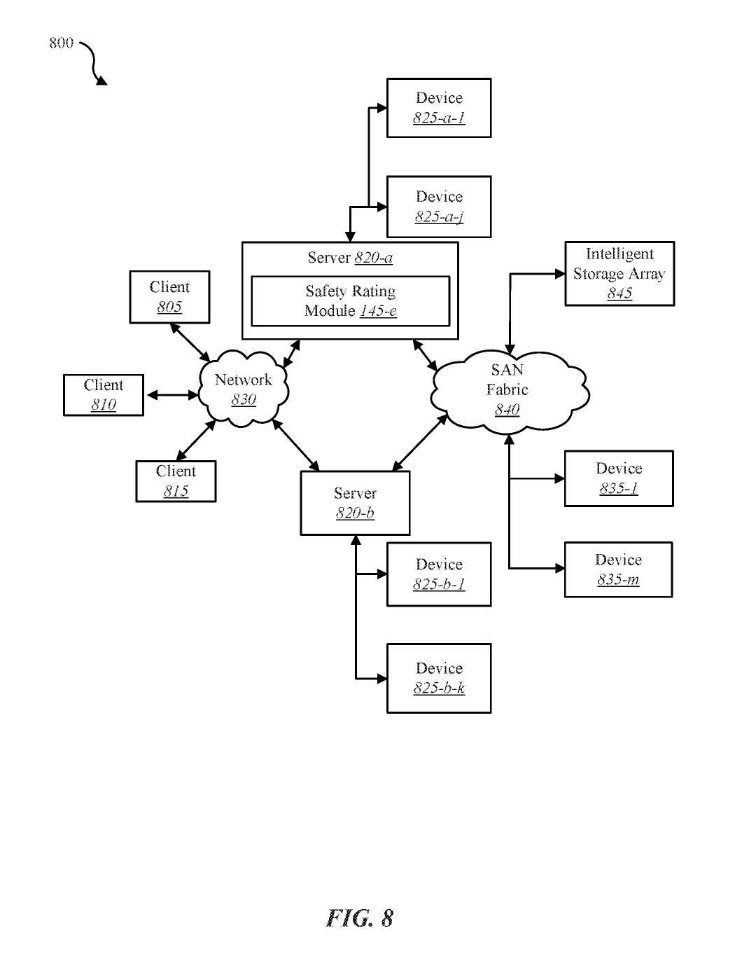

FIG. 8 is a block diagram depicting a network architecture 800 in which client systems 805, 810 and 815, as well as storage servers 820-a and 820-b (any of which can be implemented using computer system 600), are coupled to a network 830. In one embodiment, safety prediction module 145-e may be located within one of the storage servers 820-a, 820-b to implement the present systems and methods. Safety prediction module 145-e may be one example of safety prediction module 145 depicted in FIGS. 1, 2, and/or 6. The storage server 820-a is further depicted as having storage devices 825-a-1 through 825-a-j directly attached, and storage server 820-b is depicted with storage devices 825-b-1 through 825-b-k directly attached. SAN fabric 840 supports access to storage devices 835-1 through 835-m by storage servers 820-a and 820-b, and so by client systems 805, 810 and 815 via network 830. Intelligent storage array 845 is also shown as an example of a specific storage device accessible via SAN fabric 840.

With reference to computer system 600, network interface 685 or some other method can be used to provide connectivity from each of client computer systems 805, 810 and 815 to network 830. Client systems 805, 810 and 815 are able to access information on storage server 820-a or 820-b using, for example, a web browser or other client software (not shown). Such a client allows client systems 805, 810 and 815 to access data hosted by storage server 820-a or 820-b or one of storage devices 825-a-1 to 825-a-j, 825-b-1 to 825-b-k, 835-l to 835-m or intelligent storage array 845. FIG. 8 depicts the use of a network such as the Internet for exchanging data, but the present systems and methods are not limited to the Internet or any particular network-based environment.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A method for predicting future safety incidents, at least a portion of the method being performed by one or more computing devices comprising at least one processor, the method comprising:
analyzing a plurality of incidents in real time based at least in part on one or more incident criteria;
identifying an incident trend among at least one of the one or more incident criteria analyzed;
analyzing a training history of at least a first organization that is associated with the incident trend;
analyzing a training history of a second organization; and
using machine learning to predict a future occurrence of an incident associated with the incident trend based at least in part on the analysis of the training history of the second organization.

2. The method of claim 1, wherein the training history of at least the first organization is based on at least one of a tracked adherence to a training policy, a tracked level of effectiveness of the training policy, a tracked adherence to a safety policy, a tracked level of effectiveness of the safety policy, or any combination thereof, of at least one person associated with the incident trend.

3. The method of claim 2, comprising:
modifying enforcement of the training policy or the safety policy, or both, of at least the first organization upon determining the training history indicates a lack of adherence to at least one of the training policy and the safety policy is likely contributing to the incident trend.

4. The method of claim 2, comprising:
modifying one or more aspects of the training policy or the safety policy, or both, upon determining the training history indicates sufficient adherence by at least the first organization to the training policy and the safety policy.

5. The method of claim 1, wherein the one or more incident criteria include at least one of an incident type, an incident industry, an incident organization, an incident person or group of persons, an incident location, or any combination thereof.

6. The method of claim 5, wherein the incident location includes at least one of a job site, an office site, a geographic region, a state or providence, a country, or any combination thereof.

7. The method of claim 5, wherein the incident type includes a safety violation, a health violation, an environmental violation, accidents involving injury to one or more persons, accidents involving injury to property. accidents involving injury to property, or any combination thereof.

8. The method of claim 7, wherein the injury to one or more persons includes injuries or illnesses that result in unconsciousness, lost work days, restriction in work activity, job transfers, or medical care beyond first aid.

9. The method of claim 1, wherein the incident trend includes two or more occurrences of incidents sharing at least one common incident criteria.

10. The method of claim 1, wherein the second organization does not contribute to the incident trend.

11. A computing device configured for predicting future safety incidents, comprising:
one or more processors;
memory in electronic communication with the one or more processors, wherein the memory stores computer executable instructions that when executed by the one or more processors cause the one or more processors to perform the steps of:
analyzing a plurality of incidents in real time based at least in part on one or more incident criteria;
identifying an incident trend among at least one of the one or more incident criteria analyzed;
analyzing a training history of at least a first organization that is associated with the incident trend;
analyzing a training history of a second organization; and
using machine learning to predict a future occurrence of an incident associated with the incident trend based at least in part on the analysis of the training history of the second organization.

12. The computing device of claim 11, wherein the training history of at least the first organization is based on at least one of a tracked adherence to a training policy, a tracked level of effectiveness of the training policy, a tracked adherence to a safety policy, a tracked level of effectiveness of the safety policy, or any combination thereof, of at least one person associated with the incident trend.

13. The computing device of claim 12, wherein the instructions executed by the one or more processors cause the one or more processors to perform the steps of:
modifying enforcement of the training policy or the safety policy, or both, of at least the first organization upon determining the training history indicates a lack of adherence to at least one of the training policy and the safety policy is likely contributing to the incident trend.

14. The computing device of claim 12, wherein the instructions executed by the one or more processors cause the one or more processors to perform the steps of:
modifying one or more aspects of the training policy or the safety policy, or both, upon determining the training history indicates sufficient adherence by at least the first organization to the training policy and the safety policy.

15. The computing device of claim 11, wherein the one or more incident criteria include at least one of an incident type, an incident industry, an incident organization, an incident person or group of persons, an incident location, or any combination thereof.

16. The computing device of claim 15, wherein the incident location includes at least one of a job site, an office site, a geographic region, a state or providence, a country, or any combination thereof.

17. The computing device of claim 15, wherein the incident type includes a safety violation, a health violation, an environmental violation, accidents involving injury to one or more persons, accidents involving injury to property, accidents involving injury to property, or any combination thereof.

18. The computing device of claim 11, wherein the incident trend includes two or more occurrences of incidents sharing at least one common incident criteria, and wherein the second organization does not contribute to the incident trend.

19. A computer-program product for predicting future safety incidents, the computer-program product comprising a non-transitory computer-readable medium storing instructions thereon, the instructions being executable by one or more processor to perform the steps of:
analyzing a plurality of incidents in real time based at least in part on one or more incident criteria;
identifying an incident trend among at least one of the one or more incident criteria analyzed;
analyzing a training history of at least a first organization that is associated with the incident trend;
analyzing a training history of a second organization; and
using machine learning to predict a future occurrence of an incident associated with the incident trend based at least in part on the analysis of the training history of the second organization.

20. The computer-program product of claim 19, wherein the training history of at least the first organization is based on at least one of a tracked adherence to a training policy, a tracked level of effectiveness of the training policy, a tracked adherence to a safety policy, a tracked level of effectiveness of the safety policy, or any combination thereof, of at least one person associated with the incident trend.
